(19) United States
(12) Patent Application Publication
(10) Pub. No.: US 2012/0188212 A1
(43) Pub. Date: Jul. 26, 2012

(54) DISPLAY APPARATUS

(75) Inventors: Keiichi Ina, Osaka-shi (JP); Yasuyoshi Kaise, Osaka-shi (JP); Keisuke Yoshida, Osaka-shi (JP); Kazuhiro Maeda, Osaka-shi (JP)

(73) Assignee: SHARP KABUSHIKI KAISHA, Osaka-shi, Osaka (JP)

(21) Appl. No.: 13/498,587

(22) PCT Filed: Jun. 4, 2010
(86) PCT No.: PCT/JP2010/059535

§ 371 Date: Mar. 28, 2012

(30) Foreign Application Priority Data
Oct. 20, 2009 (JP) 2009-241320

(51) Int. Cl. G09G 5/00

(52) U.S. Cl. 345/207; 345/209

(57) ABSTRACT

Provided is a display apparatus wherein a sustain capacitance wire is shared between two rows of pixels to prevent the reduction in aperture ratio and the reduction in yield, and further the capacitive coupling drive can be performed. The display apparatus comprises: pixels arranged in a matrix of n rows and m columns (where n and m represent integers equal to or greater than two); m source lines and n gate lines provided in a grid pattern; and a sustain capacitance unit formed in a boundary area between odd-numbered and even-numbered rows of pixels. The sustain capacitance unit comprises: a sustain capacitance wire shared between the odd-numbered and even-numbered rows of pixels; an insulating film; an opposite electrode used for the odd-numbered row of pixels; and an opposite electrode used for the even-numbered row of pixels. The odd-numbered row of pixels each have a pixel electrode electrically connected to the opposite electrode used for the odd-numbered row of pixels, and the even-numbered row of pixels each have a pixel electrode electrically connected to the opposite electrode used for the even-numbered row of pixels. The polarity of the potential of the pixel electrode is reversed for every two rows of pixels sharing the sustain capacitance wire, while the potential of the sustain capacitance wire is varied to vary the potentials of the pixel electrodes of the two rows of pixels, thereby performing the capacitive coupling drive.

### TECHNICAL FIELD

The present invention relates to a display apparatus. The present invention specifically relates to an active-matrix-drive display apparatus in which a storage capacitance is formed in pixels.

### BACKGROUND ART

Active matrix-type display apparatuses comprising a TFT (thin film transistor) as a switching element are currently known. Such a liquid crystal display apparatus comprises a display panel, such as a liquid crystal display panel, comprising two insulating substrates opposite to each other and a liquid crystal layer disposed therebetween. One of the substrates of the display panel is provided with gate lines (scan signal lines) and source lines (image signal lines) in a grid pattern, and pixel electrodes for forming images are arranged in a matrix pattern thereon. TFTs are disposed near the respective intersection points of the gate lines and the source lines, thereby controlling application of voltages to the pixel electrodes. The other substrate of the display panel is provided with a common electrode for applying voltages between the respective pixel electrodes and itself. The respective pixel electrodes and the common electrode together form a capacitance.

In such a display apparatus, the gate lines are successively selected in each horizontal scan period and application of a scanning signal to the respective gate lines is repeated at a cycle of one vertical scan period. Thus, an electric charge stored in the capacitances, such as liquid crystal capacitances, formed by the pixel electrodes and the common electrode must be stored for a substantially one vertical scan period. If the above capacitance cannot store the electric charge only by itself, a storage capacitance is disposed in parallel with this capacitance. The storage capacitance is generally formed by a pixel electrode or an opposite electrode electrically connected to the pixel electrode and a storage capacitance wire.

The storage capacitance wire enables to perform capacitance-coupling drive which pushes up the potentials of the respective pixels of the pixel electrodes. Thereby, the amplitude of the voltage of a source signal can be reduced and sufficient contrast can be achieved. Disclosed examples of such capacitance-coupling drive include a liquid crystal display apparatus with an active matrix substrate wherein a signal to be supplied is divided into an original scanning signal (source signal) that consists of an ON potential (Vgt) and OFF potential (Vgb) for a switching element and two bias potentials (Ve(+) and Ve(−)) that compensate reduction in an potential due to a parasitic capacitance and a threshold voltage of a liquid crystal so as to reduce the maximum amplitude of the scanning signal applied to the switching element, thereby increasing reliability and reducing a cost (for example, see Patent Document 1). Examples further include a liquid crystal display apparatus wherein the output of a common electrode line drive circuit can be performed with only two values, so that the structure of the output circuit can be simplified, and the brightness can be controlled by making one of the two potentials variable (for example, see Patent Document 2).

In display apparatuses, alternating drive is performed in order to suppress deterioration of a liquid crystal and maintain display quality. In general, the polarity of the potentials of the pixel electrodes is reversed every row of pixels (this is also referred to as 1H [Horizontal] line inversion). The direction parallel to the gate lines is referred to as horizontal herein.

Display apparatuses, especially optical sensor-mounted apparatuses, perform the aforementioned 1H line inversion and are made to comprise a storage capacitance wire shared between pixels in an odd-numbered row and pixels in an even-numbered row in order to provide a pixel structure including a space for disposing an additional circuit such as an optical sensor circuit. Such a display apparatus is disclosed in which a storage capacitance wire is shared between pixels in an odd-numbered row and pixels in an even-numbered row (for example, see Patent Document 3).

### PRIOR ART REFERENCES

### Patent Documents

Patent Document 1: JP 10-39277 A

Patent Document 2: JP 2001-83943 A

Patent Document 3: WO 2009-041112

### DISCLOSURE OF THE INVENTION

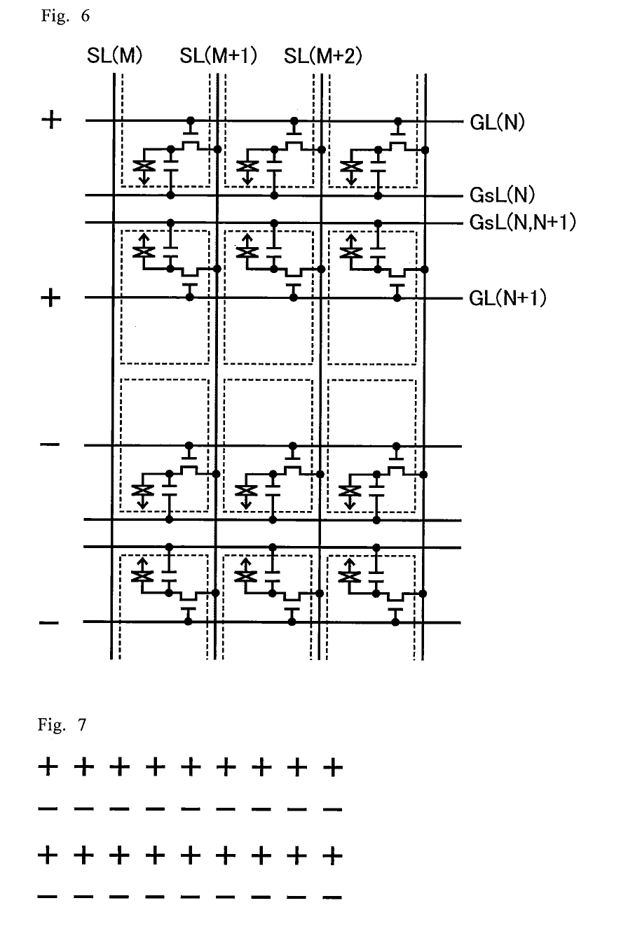

In a display apparatus which performs 1H line inversion, one pixel shows polarity different from those of the pixels just above and below. Thus, the manner of receiving the influence of changes in the potentials of the above and below pixels does not change, and no problems such as fringes occur due to such influence even though the pixels receive the uniform-display signals. Therefore, the design requires no consideration of the influence. In contrast, push up and push down of the potentials of the pixel electrodes by capacitance coupling are performed in every row of pixels. Thus, in the aforementioned display apparatus which performs 1H line inversion, capacitance-coupling drive cannot be performed by utilizing a storage capacitance wire shared between two rows of pixels. In order to make a pixel structure including a space for disposing an additional circuit such as an optical sensor circuit and to perform capacitance-coupling drive therein, a storage capacitance wire 24 is placed in a divided manner as shown in FIG. 5. FIG. 6 is a schematic plan view showing, with circuit symbols, a circuit structure of pixels on an active matrix substrate of the display apparatus shown in FIG. 5. FIG. 7 is a schematic diagram showing 1H line inversion in a conventional display apparatus. In FIG. 7, one symbol + or − corresponds to one pixel and shows the polarity of the potential of the pixel electrode of the pixel.

The display apparatus in which a storage capacitance wire is shared between two rows of pixels can be further improved in the contrast ratio by applying capacitance-coupling drive and decreasing the amplitude of a voltage of a source signal. In addition, the display apparatus shown in FIG. 5 in which the storage capacitance wire 24 is divided can be further improved for a sufficiently excellent pixel aperture ratio and yield. In other words, the display apparatus is desired to perform capacitance-coupling drive while reduction in the pixel aperture ratio and reduction in the yield are sufficiently prevented, as a display apparatus in which a storage capacitance wire is shared between two rows of pixels.

The present invention is devised in the above situation, and aims to provide a display apparatus which can perform capacitance-coupling drive while reduction in the aperture ratio and reduction in the yield are sufficiently prevented as a display apparatus in which a storage capacitance wire is shared between two rows of pixels.

The present inventors have performed various studies on a display apparatus which can perform capacitance-coupling drive while a storage capacitance wire is shared between two rows of pixels in a storage capacitance unit and reduction in the aperture ratio and reduction in the yield are sufficiently prevented, and have focused on the polarity of the potential of each pixel electrode in the display apparatus. Then, the inventors have found that, in the display apparatus, capacitance-coupling drive which varies the potentials of the pixel electrodes in the two rows of pixels can be performed by reversing the polarity of the potentials of the pixel electrodes every two rows of pixels sharing a storage capacitance wire. As a result, the inventors also have found advantages of performing capacitance-coupling drive and an effect of improving the aperture ratio by allowing two rows of pixels to share a storage capacitance wire and thereby reducing the area occupied by the storage capacitance wire, and have found that the product yield can be improved by simplifying the pattern of a storage capacitance wire. Therefore, the inventors have arrived at the solution of the above problems and completed the present invention.

In other words, the present invention relates to a display apparatus comprising:

pixels arranged in a matrix pattern of n rows and m columns where n and m each represent an integer of 2 or greater;

m source lines and n gate lines disposed in a grid pattern; and

a storage capacitance unit at a boundary area between pixels in an odd-numbered row and pixels in an even-numbered row,

the storage capacitance unit comprising:
a storage capacitance wire shared between the pixels in the odd-numbered row and the pixels in the even-numbered row;
an insulating film;
opposite electrodes for the pixels in the odd-numbered row; and
opposite electrodes for the pixels in the even-numbered row,

the pixels in the odd-numbered row being provided with pixel electrodes electrically connected to the opposite electrodes for the pixels in the odd-numbered row,

the pixels in the even-numbered row being provided with pixel electrodes electrically connected to the opposite electrodes for the pixels in the even-numbered row,

polarity of potentials of the pixel electrodes being reversed every two rows of pixels sharing the storage capacitance wire, and

the display apparatus performing capacitance-coupling drive which varies the potentials of the pixel electrodes for the pixels in the two rows by changing a potential of the storage capacitance wire. The pixels arranged in a matrix pattern are multiple pixels placed in row directions and column directions, and include pixels arranged in a delta pattern.

The display apparatus of the present invention can drive two rows of pixels sharing a storage capacitance wire by voltages at the same polarity by reversing the polarity of the potential of each pixel electrode every two rows of pixels sharing a storage capacitance wire (also referred to as 2H line inversion). Thus, the potentials of the pixel electrodes for the two rows of pixels can be changed by changing the potential of the storage capacitance wire. In other words, capacitance-coupling drive can be performed without dividing the storage capacitance wire. Therefore, reduction in the aperture ratio can be sufficiently prevented. Further, reduction in the yield due to short circuit between the divided storage capacitance wires can be sufficiently prevented. Furthermore, advantages of performing capacitance-coupling drive can be achieved.

The pixel potential in the capacitance-coupling drive is represented by the following formula:

Vₚᵢₓ=Vₛₗ+C_{cs}/Cₚᵢₓ×ΔV_{cs}

provided that Vₚᵢₓ represents a pixel potential; Vₛₗ represents a voltage of a source signal; V_{cs} represents a voltage of a storage capacitance wire; C_{cs} represents a storage capacitance; and Cₚᵢₓ represents a pixel capacitance (=storage capacitance+liquid crystal capacitance+parasitic capacitance).

In the display apparatus of the present invention, the Vₛₗ amplitude can be more reduced than in a conventional drive owing to the capacitance-coupling drive. Further, the Vₛₗ amplitude has a limit due to restriction on a driver, and thus high voltage application can be allowed by the capacitance-coupling drive. The high voltage application enables to improve the transmissivity of a liquid crystal panel, and further the brightness (display performance) of the liquid crystal panel. In addition, the storage capacitance wire is not required to be divided into two lines. Thus, reduction in the yield due to a leak between the divided storage capacitance lines can be avoided, and this yield improvement enables to reduce a cost.

The storage capacitance unit comprises a storage capacitance wire shared between pixels in an odd-numbered row and pixels in an even-numbered row, an insulating film, an opposite electrode for the pixels in the odd-numbered row, and an opposite electrode for the pixels in the even-numbered row.

In other words, the storage capacitance wire alone forms a storage capacitance for two rows of pixels, which means a storage capacitance wire is disposed every two rows of pixels in comparison with a conventional apparatus in which a wire is disposed for each row of pixels. Thus, the storage capacitance wire is placed every other boundary area between pixels in an odd-numbered row and pixels in an even-numbered row which exist in parallel. Therefore, the footprint of the storage capacitance wire can be reduced and the aperture ratio can be improved in comparison with a display apparatus in which a storage capacitance wire is placed for each pixel. Further, the electric resistance can be reduced and advantages such as suppression of cross-talking can be achieved by widening the wire width of each storage capacitance wire instead of reducing the footprint of the storage capacitance wire or in addition to reducing the footprint of the storage capacitance wire. Furthermore, the yield can be improved by simplifying the pattern of storage capacitance wires. The present invention can also be mentioned that it achieves advantages of using such a storage capacitance wire shared between pixels in an odd-numbered row and pixels in an even-numbered row in addition to the advantages of performing capacitance-coupling drive. In the present invention, at least one of the storage capacitance wire and the opposite electrode is preferably formed from a light-shielding conductive material such as metal. The storage capacitance wire is preferably opposite to the opposite electrodes for pixels in an odd-numbered row and the opposite electrodes for pixels in an even-numbered row across the insulating film. The aforementioned opposite electrode means an electrode for a storage capacitance opposite to the storage capacitance wire.

Examples of preferable configurations of the display apparatus of the present invention include a configuration in which the display apparatus of the present invention includes pixels in an odd-numbered row and pixels in an even-numbered row having reversed structures. In this configuration, the opposite electrodes for the pixels in the odd-numbered row and the opposite electrodes for the pixels in the even-numbered row are closed to each other at the boundary area of the pixels, and thus it is easy to place a storage capacitance wire which is to be shared between the pixels in the odd-numbered row and the pixels in the even-numbered row. As a result, the effects of the present invention can be further sufficiently exerted.

Examples of preferable configurations of the display apparatus of the present invention include a configuration in which the display apparatus has an additional circuit shared between pixels in an odd-numbered row and pixels in an even-numbered row with no storage capacitance wire disposed therebetween. In the present invention, the display apparatus with the above pixel structure performs capacitance-coupling drive and the storage capacitance wire is disposed every two rows of pixels. Thus, an area between pixels in an odd-numbered row and pixels in an even-numbered row where no storage capacitance wire is disposed therebetween can be practically used. For example, an additional circuit to be shared at this area can be placed, and this placement enables to improve the aperture ratio in comparison with the case that additional circuits for respective pixels are formed in a different area. Examples of the additional circuit include a circuit for an optical sensor and a memory circuit. In particular, a configuration in which the additional circuit is a circuit for an optical sensor is preferable.

The aforementioned configurations may be employed in appropriate combination as long as the combination is not beyond the spirit of the present invention.

### Effects of the Invention

According to the present invention, the display apparatus in which a storage capacitance wire is shared between pixels in an odd-numbered row and pixels in an even-numbered row can perform capacitance-coupling drive, the footprint of the storage capacitance wire can be reduced, and the aperture ratio can be improved. Further, the yield can be improved by simplifying the pattern of the storage capacitance wire.

### BRIEF DESCRIPTION OF THE DRAWINGS

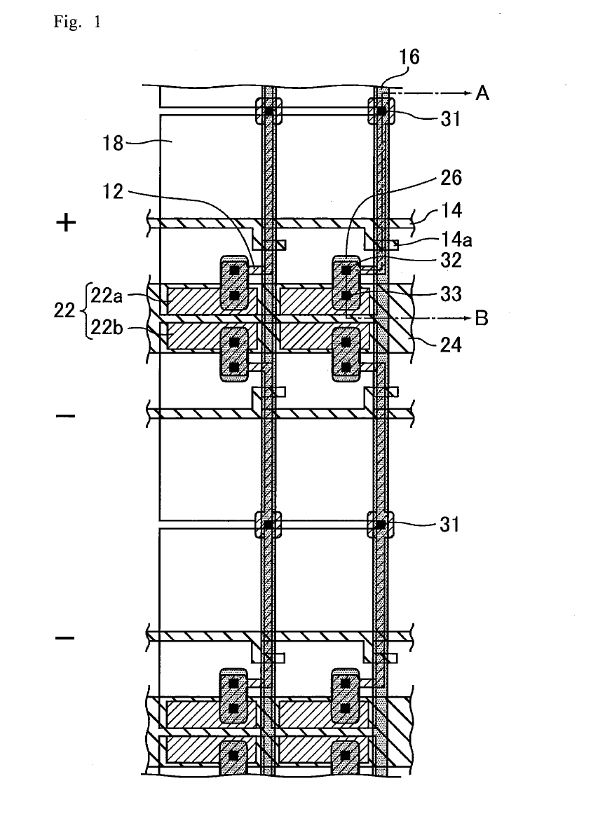

### [FIG. 1]

FIG. 1 is a schematic plan view showing a circuit structure of pixels on an active matrix substrate in a display apparatus of Embodiment 1.

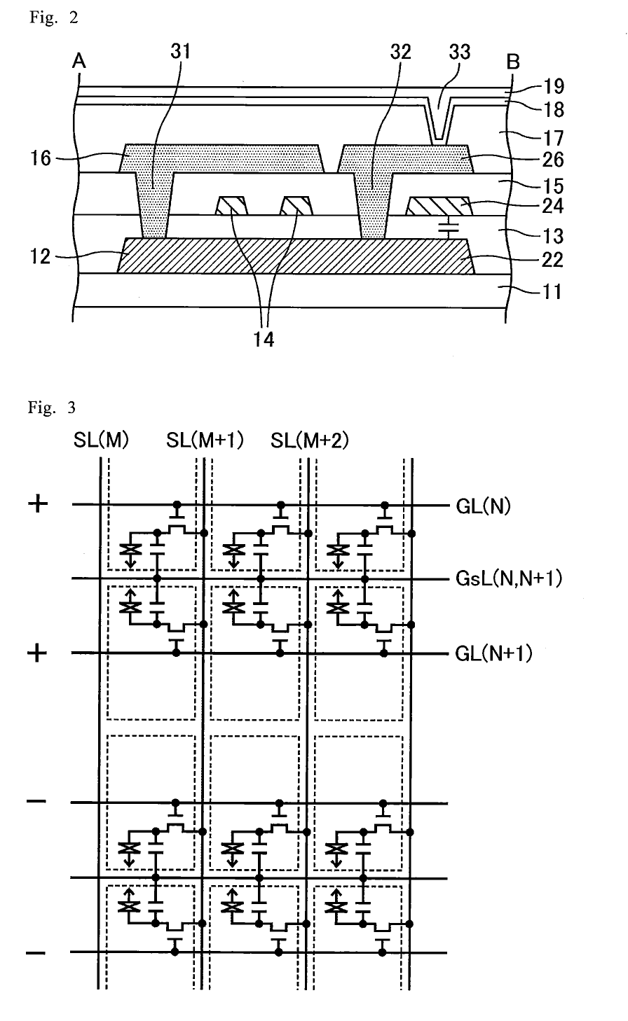

### [FIG. 2]

FIG. 2 is a schematic cross-sectional view showing a cross section along the A-B line in FIG. 1.

### [FIG. 3]

FIG. 3 is a schematic plan view showing, with circuit symbols, the circuit structure of the pixels on the active matrix substrate in the display apparatus of Embodiment 1.

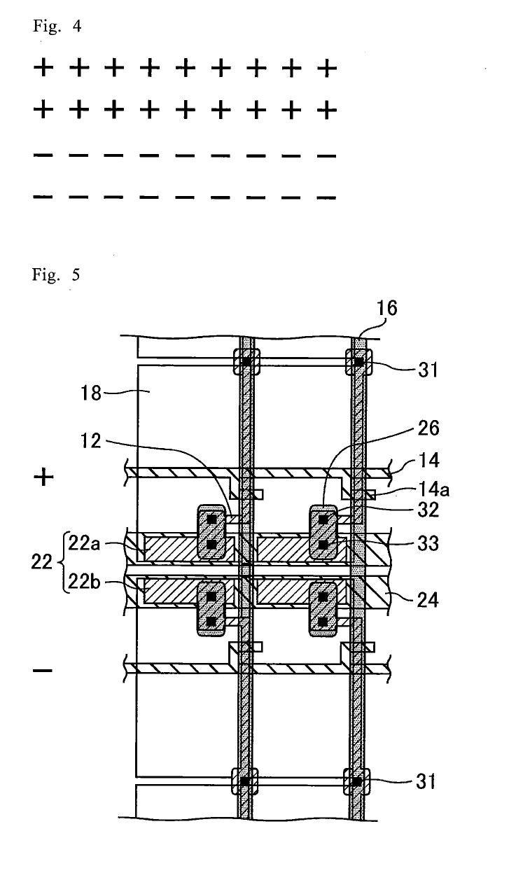

### [FIG. 4]

FIG. 4 is a schematic diagram showing 2H line inversion in the display apparatus of Embodiment 1.

### [FIG. 5]

FIG. 5 is a schematic plan view showing a circuit structure of pixels on an active matrix substrate in a conventional display apparatus.

### [FIG. 6]

FIG. 6 is a schematic plan view showing, with circuit symbols, a circuit structure of pixels on an active matrix substrate in a conventional display apparatus.

### [FIG. 7]

FIG. 7 is a schematic diagram showing 1H line inversion in the conventional display apparatus.

### MODES FOR CARRYING OUT THE INVENTION

The present invention will be mentioned in more detail in the following embodiment, but is not limited to this embodiment. For example, the following embodiment relates to a liquid crystal display apparatus; however, the display apparatus of the present invention is not limited thereto.

### Embodiment 1

The liquid crystal display apparatus of the present embodiment comprises pixels arranged in a matrix pattern of n rows and m columns (n and m each represent an integer of 2 or greater), and m source lines and n gate lines disposed in a grid pattern.

The liquid crystal display apparatus of the present embodiment controls pixel driving on an active matrix substrate on which thin film transistors (TFTs) and pixel electrodes are arranged in a matrix pattern for the respective pixels. FIG. 1 is a schematic plan view showing the circuit structure of the pixels on the active matrix substrate in the display apparatus of Embodiment 1. FIG. 2 is a schematic cross-sectional view showing the structure of the cross section along the A-B line in FIG. 1.

As shown in FIG. 1, the TFTs and the pixel electrodes 18 are disposed for the respective pixels on the active matrix substrate. Each TFT has a structure that a portion connected to a source line 16 through a first contact hole 31 is formed at one side of the portion where a TFT semiconductor layer 12 formed from silicon and a gate line 14 overlap each other with a gate insulating film interposed therebetween, and a portion connected to the pixel electrode 18 through second and third contact holes 32 and 33 is formed at the other side. As a scanning signal is supplied through the gate line 14, the TFT semiconductor layer 12 is allowed to have continuity, and an image signal supplied through the source line 16 is supplied to the pixel electrode 18.

As shown in FIG. 1, in the present embodiment, the pixels in an odd-numbered row shown at the upper portion in FIG. 1 and the pixels in an even-numbered row shown at the middle portion in FIG. 1 have reversed structures, and they are in a relation of line symmetry with the border between the pixels in an odd-numbered row and the pixels in an even-numbered row as the center line. Thus, opposite electrodes 22a for the pixels in an odd-numbered row and opposite electrodes 22b for the pixels in an even-numbered row are close to each other at the boundary area between the pixels, and a storage capacitance wire 24 shared between the pixels in an odd-numbered row and the pixels in an even-numbered row can be easily placed. In the present embodiment, each opposite electrode 22a is disposed so as to be covered with the lower end of the pixel electrode 18 in each pixel in an odd-numbered row and each opposite electrode 22b is disposed so as to be covered with the upper end of the pixel electrode 18 in each pixel in an even-numbered row. The storage capacitance wire 24 is formed at an area covering the opposite electrodes 22a and 22b and an area between the opposite electrodes 22a and 22b. Further, in the present embodiment, the storage capacitance wire 24 is made thicker by a margin corresponding to the placing accuracy of the opposite electrodes 22 in order to prevent variations in storage capacitances of the respective pixels due to displacement of the opposite electrodes 22.

Further, as shown in FIG. 2, the active matrix substrate of the present embodiment has a structure formed by successively stacking a TFT semiconductor layer 12, a gate insulating film 13, a gate line 14, a first interlayer insulating film 15, a source line 16, a second interlayer insulating film 17, a pixel electrode 18, and an alignment film 19, from the side of the substrate 11. In addition, an opposite electrode 22 is formed from the same material as the TFT semiconductor layer 12 on the same layer as the TFT semiconductor layer 12, and a storage capacitance wire 24 is formed from the same material as the gate line 14 on the same layer as the gate line 14, and the opposite electrode 22 and the storage capacitance wire 24 are opposite to each other sandwiching the gate insulating film 13. The TFT semiconductor layer 12 and the opposite electrode 22 can be simultaneously formed by photolithography. Similarly, the gate line 14 and the storage capacitance wire 24 can be simultaneously formed by photolithography.

In the present embodiment, each pixel electrode 18 is rectangularly formed. For convenience, the area within the substrate face with each pixel electrode 18 disposed thereon is referred to as a pixel, the direction along the long side thereof is referred to as a longitudinal direction, and the direction along the short side thereof is referred to as a width direction. The gate lines 14 extend in the width direction at the center of the pixels, the source lines 16 extend in the longitudinal direction between the pixels, and these lines are perpendicular to each other. Each gate line 14 has a branch part 14a which branches off in the vicinity of a portion where the gate line 14 perpendicularly crosses a source line 16, and the branch part 14a also overlaps the TFT semiconductor layer 12 with a gate insulating film 13 sandwiched therebetween. As mentioned above, the gate line 14 and the TFT semiconductor layer 12 overlaps at two portions, including a branch part 14a of the gate line, in each pixel, and thus form a dual-gate structure.

In FIG. 1 and FIG. 2, the source line 16 exists at the upper right portion of a pixel, and is electrically connected to the TFT semiconductor layer 12 through a first contact hole 31 which penetrates the first interlayer insulating film 15 and the gate insulating film 13. The TFT semiconductor layer 12 linearly extends along the source line 16. It forms overlapping portions (channels) with the gate line 14 and its branch part 14a at portions near the middle of the right end of the pixel, and bends toward the middle of the pixel at a lower position of the right edge of the pixel. The TFT semiconductor layer 12 exists in the vicinity of the lower end to the right of the pixel, and is electrically connected to an island-like conductive part 26 which is disposed on the same layer as the source line 16 through a second contact hole 32 which penetrates the gate insulating film 13 and the first interlayer insulating film 15. The island-like conductive part 26 is electrically connected to the pixel electrode 18 through a third contact hole 33 which penetrates the second interlayer insulating film 17.

As shown in FIG. 1, in the present embodiment, the TFT semiconductor layers for the pixels in an odd-numbered row and the TFT semiconductor layers for the pixels in an even-numbered row are integrated. Since the TFT semiconductor layers 12 for the pixels in the same column are connected to the same source line 16 in the present embodiment, the TFT semiconductor layers for the pixels in an odd-numbered row and the TFT semiconductor layers for the pixels in an even-numbered row can be integrated. For example, in FIG. 1, the integrated TFT semiconductor layers 12 for the pixel in the middle row and the pixel in the lower row in FIG. 1 have a portion extending upward from the first contact hole 31 and used for connecting with the pixel electrode 18 for the pixel in the even-numbered row illustrated in the middle row in FIG. 1 and a portion extending downward from the first contact hole 31 and used for connecting with the pixel electrode 18 for the pixel in the odd-numbered row illustrated in the lower row in FIG. 1. As mentioned above, sharing of the first contact hole 31 between the pixel in an odd-numbered row and a pixel in an even-numbered row enables to reduce the number of contact holes and to improve the aperture ratio. Further, in the present embodiment, a storage capacitance wire 24 is disposed at the boundary area between the pixels in the odd-numbered row illustrated in the upper row in FIG. 1 and the pixels in the even-numbered row illustrated in the middle row in FIG. 1, and a first contact hole 31 is disposed between a pixel in the even-numbered row illustrated in the middle row in FIG. 1 and a pixel in the odd-numbered row illustrated in the lower row in FIG. 1. Thereby, the aperture ratio is improved.

In the present embodiment, the opposite electrode 22a for the pixels in an odd-numbered row and the opposite electrode 22b for the pixels in an even-numbered row are arranged in parallel with each other along the extending direction of the storage capacitance wire 24. In the case that the storage capacitance wire is thin or is placed so as to face the long side of the pixel electrode, the opposite electrodes may be arranged along the extending direction of the storage capacitance wire. In the parallel arrangement along the extending direction of the storage capacitance wire, a margin needs to be formed between the opposite electrodes depending on the placing accuracy of the electrodes. Thus, it may be difficult to make the storage capacitance wire thin. In contrast, in the configuration in which the opposite electrodes are arranged along the extending direction of the storage capacitance wire, a margin between the opposite electrodes has no influence on the width of the storage capacitance wire.

Further, in the present embodiment, each TFT semiconductor layer 12 is provided with one first contact hole 31 which penetrates the first interlayer insulating film 15 and the gate insulating film 13 and which electrically connects the source line 16 with the TFT semiconductor layer 12. On the other hand, each TFT semiconductor layer may be provided with multiple first contact holes. Thereby, reliability in electrical connection between the source lines and the TFT semiconductor layers can be efficiently improved.

FIG. 3 is a schematic plan view showing, with circuit symbols, the circuit structure of the pixels on the active matrix substrate in the display apparatus of Embodiment 1.

With respect to Embodiment 1 referring to FIG. 3, the present embodiment relates to a configuration in which a storage capacitance wire is disposed at a boundary area between pixels in an odd-numbered row (Nth row) and pixels in an even-numbered row ((N+1)th row). In FIG. 3, G_{S}L(N, N+1) represents a storage capacitance wire used for driving pixels in the Nth row and the (N+1)th row, GL(N) and GL(N+1) represent gate lines used for driving the pixels in the Nth row and the (N+1)th row, respectively, and SL(M), SL(M+1), and SL(M+2) represent source lines used for driving the pixels in the Mth column, the (M+1)th column, and the (M+2)th column, respectively.

FIG. 4 is a schematic diagram showing 2H line inversion in the display apparatus of Embodiment 1. In FIG. 4, one symbol + or − corresponds to one pixel, and represents the polarity of the potential of each pixel electrode in the pixel.

In the liquid crystal display apparatus of Embodiment 1, two rows of pixels sharing one storage capacitance wire 24 can be driven by voltages with the same polarity in the case that the polarity of the potential of each pixel electrode are reversed every two rows of pixels sharing the storage capacitance wire 24. Thus, the potential of the pixel electrode 18 for each pixel in the two rows can be changed by changing the potential of the storage capacitance wire 24. Therefore, capacitance-coupling drive can be performed, and further the footprint of the storage capacitance wire 24 can be reduced and the aperture ratio can be improved. In addition, the yield can be improved as a result of simplifying the pattern of the storage capacitance wire 24.

As one modified example of Embodiment 1, the display apparatus may have a configuration that a storage capacitance wire is disposed at a boundary area between the pixels in an odd-numbered row and the pixels in an even-numbered row as shown in FIG. 1 and part of a circuit for an optical sensor as an additional circuit is formed between the pixels in the even-numbered row ((N+1)th row) and the pixels in the adjacent odd-numbered row ((N+2)th row). The circuit for an optical sensor periodically repeats the cycle of (1) initialization, (2) sensing, and (3) readout. Such a circuit for an optical sensor enables to give additional functions such as touch panel function to the display apparatus of the present invention.

In the modified example of Embodiment 1, one storage capacitance wire is disposed every two rows of pixels instead of disposing one wire for each row of pixels as in the conventional structure, and an additional circuit is placed at a space thereby formed. In other words, an additional circuit to be shared is placed between pixels in an odd-numbered row and pixels in an even-numbered row where no storage capacitance wire is placed. Therefore, reduction in the aperture ratio due to an additional circuit is suppressed.

The liquid crystal display apparatus of the present embodiment may be modified or varied as long as the modification or variation is not beyond the technical scope and the spirit of the present invention. For example, while the opposite electrode is placed at a layer lower than the storage capacitance wire in Embodiment 1, it may be placed at a layer upper than the storage capacitance wire. In such a case, the opposite electrode may be integrally formed with the pixel electrode. That is, an interlayer insulating film at an area where an opposite electrode is to be formed is opened in advance, and then a conductive film is formed on the whole surface of the substrate, thereby integrally forming a pixel electrode on the interlayer insulating film and an opposite electrode under the opening portion of the interlayer insulating film through the conductive film.

Further, the display mode may be a twisted nematic (TN) mode or a vertical alignment (VA) mode, for example, in which a pixel electrode and a common electrode are placed on different substrates, or may be an in-plane switching (IPS) mode in which a pixel electrode and a common electrode are placed on one of the substrates.

The liquid crystal display apparatus of Embodiment 1 may be any of a transmissive liquid crystal display apparatus, a reflective liquid crystal display apparatus, and a transflective liquid crystal display apparatus.

The aforementioned configurations in the embodiments may be employed in appropriate combination as long as the combination is not beyond the spirit of the present invention.

The present application claims priority to Patent Application No. 2009-241320 filed in Japan on Oct. 20, 2009 under the Paris Convention and provisions of national law in a designated State, the entire contents of which are hereby incorporated by reference.

### EXPLANATION OF REFERENCE NUMERALS

11 substrate

12 TFT semiconductor layer

13 gate insulating film

14 gate line

14a branch part

15 first interlayer insulating film

16 source line

17 second interlayer insulating film

18 pixel electrode

19 alignment film

22 opposite electrode

22a opposite electrode for pixel in odd-numbered row

22b opposite electrode for pixel in even-numbered row

24 storage capacitance wire

26 conductive part

31 first contact hole

32 second contact hole

33 third contact hole

1. A display apparatus comprising:
pixels arranged in a matrix pattern of n rows and m columns where n and m each represent an integer of 2 or greater;
m source lines and n gate lines disposed in a grid pattern; and
a storage capacitance unit at a boundary area between pixels in an odd-numbered row and pixels in an even-numbered row,
the storage capacitance unit comprising:
a storage capacitance wire shared between the pixels in the odd-numbered row and the pixels in the even-numbered row;
an insulating film;
opposite electrodes for the pixels in the odd-numbered row; and
opposite electrodes for the pixels in the even-numbered row,
the pixels in the odd-numbered row being provided with pixel electrodes electrically connected to the opposite electrodes for the pixels in the odd-numbered row,
the pixels in the even-numbered row being provided with pixel electrodes electrically connected to the opposite electrodes for the pixels in the even-numbered row,
polarity of potentials of the pixel electrodes being reversed every two rows of pixels sharing the storage capacitance wire, and
the display apparatus performing capacitance-coupling drive which varies the potentials of the pixel electrodes for the pixels in the two rows by changing a potential of the storage capacitance wire.

2. The display apparatus according to claim 1,
wherein each pixel in an odd-numbered row has a reversed structure to that of each pixel in an even-numbered row.

3. The display apparatus according to claim 1, further comprising
an additional circuit shared between pixels in an odd-numbered row and pixels in an even-numbered row with no storage capacitance wire disposed therebetween.

4. The display apparatus according to claim 3,
wherein the additional circuit is a circuit for an optical sensor.
